(19) United States
(12) Patent Application Publication
(10) Pub. No.: US 2003/0076422 A1
(43) Pub. Date: Apr. 24, 2003

(54) Control cable extension unit for pan/tilt camera

(75) Inventors: Tomokazu Ito, Toyoake (JP); Hiroyuki Mishima, Iwakura (JP)

Correspondence Address: Koda & Androlia, Suite 3850, 2029 Century Park East, Los Angeles, CA, 90067, US

(73) Assignee: Elmo Co., Ltd.

(21) Appl. No.: 10/234,601

(22) Filed: Sep. 4, 2002

(30) Foreign Application Priority Data
Oct. 22, 2001 (JP) 2001-323714

(51) Int. Cl. H04N 7/18

(52) U.S. Cl. 348/211.5; 348/211.99; 348/211.1; 348/156

(57) ABSTRACT

A control cable extension unit for a pan/tilt camera is used between the pan/tilt camera and a pan/tilt camera controller and is connected via a coaxial multiplex communication cable to the pan/tilt camera and is further connected via a control cable to the pan/tilt camera controller. The extension unit includes a signal input section to which the pan/tilt camera controller supplies a control signal, a signal processing section for processing the control signal supplied to the signal input section, delivering various commands for operating the pan/tilt camera a signal output section for transmitting the commands delivered by the signal processing section on the basis of a synchronizing signal to the pan/tilt camera during a blanking period in which no video signal is generated by the pan/tilt camera.

### BACKGROUND OF THE INVENTION

1. Field of the Invention

This invention relates generally to pan/tilt cameras and more particularly to a control cable extension unit used with the pan/tilt cameras.

2. Description of the Related Art

The maximum length of a control cable is limited to 15 m when a pan/tilt camera and a controller therefor are remotely controlled using a communication cable in conformity with the RS-232C Serial Interface Standard. Further, when the pan/tilt camera is controlled using an infrared remote control, the controller needs to be located in an imaginary circle with the radius of about 6.5 m about the pan/tilt camera. On the other hand, there has been a request that the pan/tilt camera should be installed as far as possible from the pan/tilt camera controller from the viewpoint of the characteristics of the pan/tilt camera.

However, the foregoing request has not been fulfilled yet as far as the communication cable in conformity with the RS-232C Serial Interface Standard is used. On the other hand, in the case where a low capacitance cable is used as the communication cable, the distance between the pan/tilt camera and the controller can be extended to about 150 m when a signaling speed is at 9600 bps. However, the cost of the communication cable is increased.

### SUMMARY OF THE INVENTION

Therefore, an object of the present invention is to provide a control cable extension unit for the pan/tilt camera which can be used for remote control of the pan/tilt camera.

The present invention provides a control cable extension unit for a pan/tilt camera, which is provided between the pan/tilt camera and a pan/tilt camera controller and which is connected via a coaxial multiplex communication cable to the pan/tilt camera and is further connected via a control cable to the pan/tilt camera controller. The extension unit comprises a signal input section to which the pan/tilt camera controller supplies a control signal, a signal processing section for processing the control signal supplied to the signal input section, delivering various commands for operating the pan/tilt camera, and a signal output section for transmitting the commands delivered by the signal processing section on the basis of a synchronizing signal to the pan/tilt camera during a blanking period in which no video signal is generated by the pan/tilt camera.

In the above-described extension unit, the signal output section transmits the commands delivered by the signal processing section on the basis of the synchronizing signal via the coaxial multiplex communication cable to the pan/tilt camera during the blanking period in which no video signal is generated by the pan/tilt camera. Since the coaxial multiplex communication cable connects between the pan/tilt camera and the extension unit, the pan/tilt camera can be installed or otherwise positioned about 500 m away from the pan/tilt camera controller. Furthermore, since a single coaxial multiplex communication cable is used between the pan/tilt camera and the extension unit, cabling can be simplified therebetween.

In a preferred form, the signal input section includes a wireless receiving section and a connecting section connecting the wireless receiving section to a communication cable, and the signal processing section includes a body comprising a microcomputer executing a processing software installed, and the signal output section is provided with a programmable logic device, a synchronization separator circuit, a bias circuit, a video output terminal and a BNC terminal.

In another preferred form, the wireless receiving section receives a remote control signal from a wireless remote control, and the signal processing section processes the remote control signal received by the wireless receiving section thereby to deliver various commands for operating the pan/tilt camera. Consequently, the pan/tilt camera can be remotely controlled, which can facilitate use of the pan/tilt camera.

In further another preferred form, the remote control signal is an infrared signal. The infrared remote control signal has a high atmospheric transmittance and can accordingly ensure reliability of the communication. Furthermore, the infrared remote control signal can reduce electric power consumption and the size of the receiving section can be reduced.

### BRIEF DESCRIPTION OF THE DRAWINGS

Other objects, features and advantages of the present invention will become clear upon reviewing the following detailed description of the invention, made with reference to the accompanying drawings, in which:

FIG. 1 is a schematic diagram showing an arrangement of a pan/tilt camera system to which the control cable extension unit in accordance with the present invention is applied; and

FIG. 2 is a schematic block diagram showing an arrangement of the extension unit.

### DETAILED DESCRIPTION OF THE INVENTION

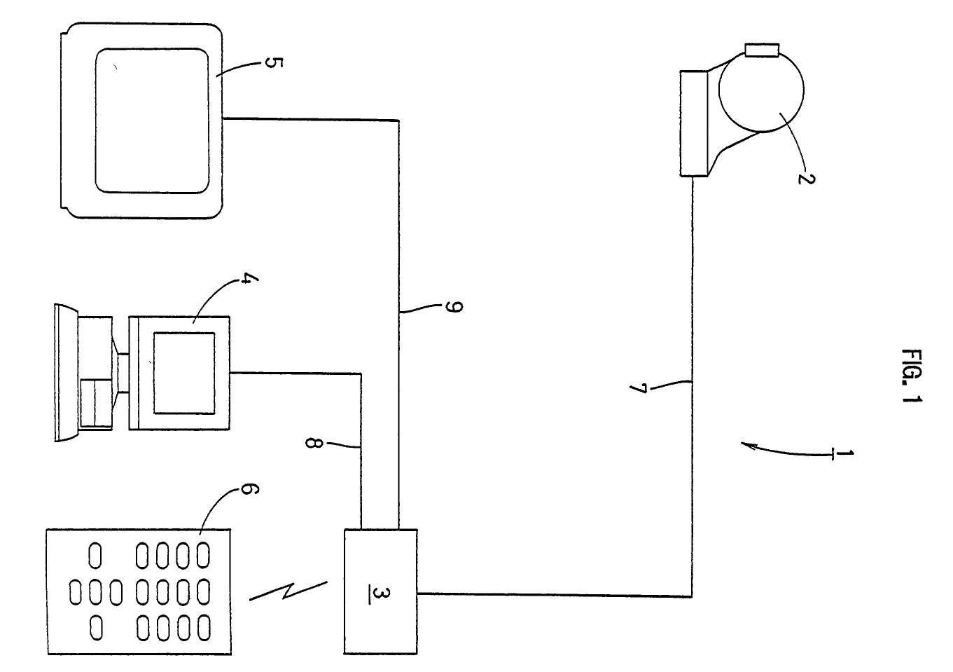

One embodiment of the extension unit in accordance with the invention will be described with reference to the accompanying drawings. Referring to FIG. 1, a schematic arrangement of a pan/tilt camera system 1 is shown. The pan/tilt camera system 1 comprises a pan/tilt camera 2, a control cable extension unit 3 for the pan/tilt camera, a personal computer 4 serving as a pan/tilt camera controller, a monitor 5 and an infrared remote control 6. The personal computer 4 controls the operation of the pan/tilt camera 2 on the basis of control software installed therein. The infrared remote control 6 transmits a remote control signal or infrared signal for controlling the operation of the pan/tilt camera 2.

The pan/tilt camera 2 and the extension unit 3 are connected to each other by a coaxial multiplex communication cable 7. The extension unit 3 and the personal computer 4 are connected to each other by a communication cable 8 in conformity with the RS-232C Serial Interface Standard. The extension unit 3 and the monitor 5 are connected to each other by a coaxial cable 9.

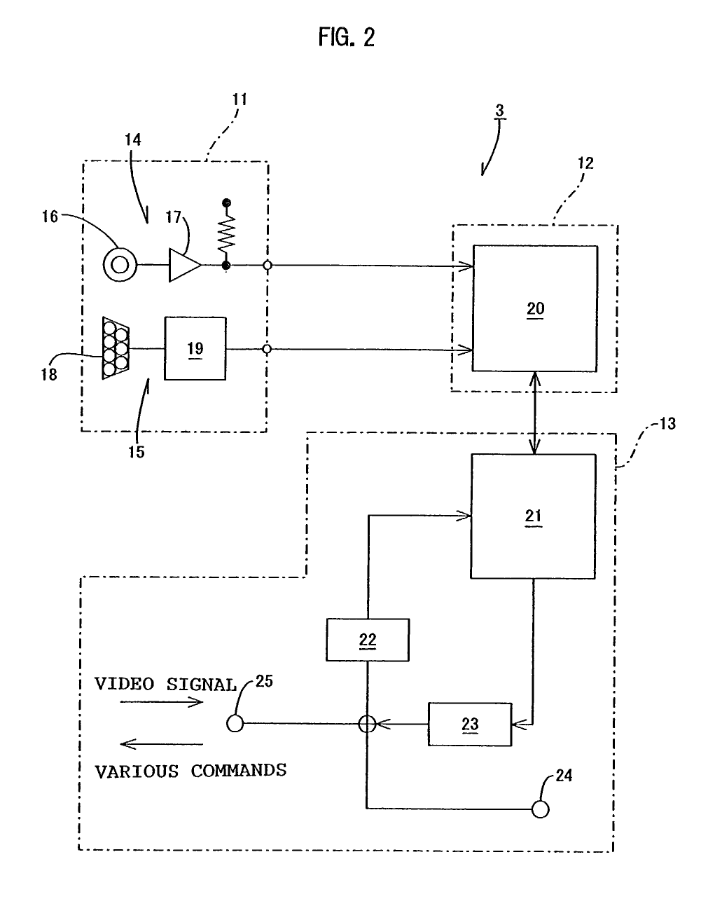

Referring now to FIG. 2, an arrangement of the extension unit 3 is schematically shown. The extension unit 3 includes a signal input section 11, a signal processing section 12 and a signal out put section 13. The signal input section 11 includes a wireless receiving section 14 and a connecting section 15 to which the communication cable 8 is adapted to be connected. The wireless receiving section 14 includes an infrared sensor 16 and an amplifier 17. An infrared remote control signal delivered by the pan/tilt camera 2 is received by the infrared sensor 16 to be supplied via the amplifier 17 to the signal processing section 12.

The connecting section 15 includes a connecting terminal 18 to which the communication cable 8 is connected and a transmitter-receiver driver 19. The personal computer 4 delivers an operation control signal for the pan/tilt camera 2. The operation control signal delivered by the personal computer 4 is supplied via the transmitter-receiver driver 19 to the signal processing section 12. The personal computer 4 delivers an inquiry signal for checking the status of the pan/tilt camera 2 and the like as well as the aforesaid operation control signal. The signal processing section 12 includes a body comprising a microcomputer 20. The microcomputer 20 processes the aforesaid remote control signal, the operation control signal and inquiry signal for the pan/tilt camera 2 thereby to deliver various commands indicative of operation of the pan/tilt camera 2 or the like.

The signal output section 13 includes a programmable logic device 21 (hereinafter referred to as “PLD”), a synchronization separator circuit 22, a bias circuit 23, a video output terminal 24 and a BNC terminal 25. The microcomputer 20 delivers an 8-bit parallel signal to PLD 21. PLD 21 converts the 8-bit parallel signal to an 8-bit serial signal, which serial signal is delivered in synchronization with a composite signal SYNC supplied thereto from the synchronization separator circuit 22. Furthermore, the synchronization separator circuit 22 eliminates a video signal from a composite VIDEO signal delivered thereto from the pan/tilt camera 2 such that the composite VIDEO signal contains only the composite SYNC signal. The bias circuit 23 converts the level of serial signal delivered from PLD 21, mixing the resultant signal with the composite VIDEO signal. The coaxial cable 9 is connected to the video output terminal 24 so that a video signal is delivered to the monitor 5. The coaxial multiplex communication cable 7 is connected to the BNC terminal 25 so that a video signal delivered from the pan/tilt camera 2 is supplied to the signal output section 13 and so that various commands are delivered to the pan/tilt camera 2 during a blanking period in which no video signal is generated by the pan/tilt camera.

In the above-described pan/tilt camera system 1, the coaxial multiplex communication cable 7 connects between the pan/tilt camera 2 and the extension unit 3. Consequently, the pan/tilt camera 2 can be installed or otherwise positioned about 500 m away from the personal computer 4 serving as the pan/tilt camera controller. Furthermore, since a single coaxial multiplex communication cable 7 is used between the pan/tilt camera 2 and the extension unit 3, cabling can be simplified therebetween.

Furthermore, the extension unit 3 includes the wireless receiving section 14 receiving the remote control signal, which signal is processed by the signal processing section 12 so that various commands for operating the pan/tilt camera 2 are delivered. Accordingly, when the infrared remote control 6 is used while being directed to the extension unit 3, the pan/tilt camera 2 can be remotely controlled about 500 m away therefrom. This can facilitate use of the pan/tilt camera 2.

The foregoing description and drawings are merely illustrative of the principles of the present invention and are not to be construed in a limiting sense. Various changes and modifications will become apparent to those of ordinary skill in the art. All such changes and modifications are seen to fall within the scope of the invention as defined by the appended claims.

What is claimed is:

1. A control cable extension unit for a pan/tilt camera, which is provided between the pan/tilt camera and a pan/tilt camera controller and which is connected via a coaxial multiplex communication cable to the pan/tilt camera and is further connected via a control cable to the pan/tilt camera controller, the extension unit comprising:
a signal input section to which the pan/tilt camera controller supplies a control signal;
a signal processing section for processing the control signal supplied to the signal input section, delivering various commands for operating the pan/tilt camera; and
a signal output section for transmitting the commands delivered by the signal processing section on the basis of a synchronizing signal to the pan/tilt camera during a blanking period in which no video signal is generated by the pan/tilt camera.

2. A control cable extension unit according to claim 1, wherein the signal input section includes a wireless receiving section and a connecting section connecting the wireless receiving section to a communication cable, wherein the signal processing section includes a body comprising a microcomputer executing a processing software installed, and wherein the signal output section is provided with a programmable logic device, a synchronization separator circuit, a bias circuit, a video output terminal and a BNC terminal.

3. A control cable extension unit according to claim 2, wherein the wireless receiving section receives a remote control signal from a wireless remote control, and the signal processing section processes the remote control signal received by the wireless receiving section thereby to deliver various commands for operating the pan/tilt camera.

4. A control cable extension unit according to claim 3, wherein the remote control signal is an infrared signal.
